(19) United States
(12) Patent Application Publication
(10) Pub. No.: US 2009/0135091 A1
(43) Pub. Date: May 28, 2009

(54) Historic Information Presentation System

(76) Inventor: Frank McDonough, Arcadia, CA (US)

Correspondence Address: MCDERMOTT WILL & EMERY LLP, 2049 CENTURY PARK EAST, 38th Floor, LOS ANGELES, CA, 90067-3208, US

(21) Appl. No.: 12/189,033

(22) Filed: Aug. 8, 2008

Related U.S. Application Data
(60) Provisional application No. 60/990,055, filed on Nov. 26, 2007.
(60) Provisional application No. 61/125,287, filed on Apr. 24, 2008.

(51) Int. Cl. G09G 5/00

(52) U.S. Cl. 345/7

(57) ABSTRACT

An information presentation system and process may create the impression in the mind of a person viewing a real scene that the real scene contains a feature that is not in the real scene at the time the real scene is being viewed by the person. The system may include a display configured to display visual images. The display may have a size that is viewable by a first eye of the person at close range without substantially blocking the view of the second eye of the person. The system may have a hooded magnifier that has an end coupled to the display and another end configured to rest against area around the first eye of the person without substantially blocking the view of the second eye of the person. The hooded magnifier may have an optical lens that is configured to comfortably allow the first eye of the person to focus on the images that are displayed by the display at close range and a hood that substantially blocks ambient light from reaching the first eye of the person when the other end of the magnifier is rested against the area around the first eye. The system may have an information storage system containing one or more images of at least a portion of the real scene with the feature in it. The system may have a processing system configured to read the one or more images from the information storage system and to cause the same to be delivered to the display.

### CROSS-REFERENCE TO RELATED APPLICATION(S)

This application is based upon and claims priority to U.S. Provisional Patent Application Ser. No. 60/990,055, filed Nov. 26, 2007, entitled “System for Viewing Video Tours on Hand-held Players Outdoors,” and U.S. Provisional Patent Application Ser. No. 61/125,287, filed Apr. 24, 2008, entitled “Boundary Effect Enhanced Handheld Interpretive & Instructional Video.” The entire content of both of these provisional applications is incorporated herein by reference.

### BACKGROUND

1. Field

This disclosure relates to information presentation systems, including information presentation systems that may be used in connection with the delivery of educational information and/or entertainment while viewing a real scene, such as a scene at which a significant historic event once took place.

2. Description of Related Art

Information about a real scene is often helpful in better understanding the real scene, appreciating its significance, and/or recalling it later.

Sometimes, the information is presented in a classroom or in some other type of setting separate from the real scene. The disassociation of the information from the real scene, however, can reduce the effectiveness of the presentation, what is gained while viewing the real scene, and/or the recollection of what is learned.

For example, students of history may sit in a dark room and watch a movie about a famous battle that once took place. The students may then travel to the where the battle once took place and view the battlefield. However, the disassociation between the movie and the observation of the real scene can diminish the effectiveness of the movie, what is gained from the viewing the real scene, and/or the recollection of one or the other.

Efforts have been made to bridge this gap. For example, viewers of historic scenes have been supplied with devices which provide audio information while viewing the real scene. Still, the effectiveness and retention of the presentation may be less than what it would have been had the real scene been viewed when the original incident that is being described with the audio took place.

### SUMMARY

An information presentation system may create the impression in the mind of a person viewing a real scene that the real scene contains a feature that is not in the real scene at the time the real scene is being viewed by the person.

The system may include a display configured to display visual images. The display may have a size that is viewable by a first eye of the person at close range without substantially blocking the view of the second eye of the person.

The system may have a hooded magnifier that has an end coupled to the display and another end configured to rest against area around the first eye of the person without substantially blocking the view of the second eye of the person. The hooded magnifier may have an optical lens that is configured to comfortably allow the first eye of the person to focus on the images that are displayed by the display at close range and a hood that substantially blocks ambient light from reaching the first eye of the person when the other end of the magnifier is rested against the area around the first eye.

The system may have an information storage system containing one or more images of at least a portion of the real scene with the feature in it.

The system may have a processing system configured to read the one or more images from the information storage system and to cause the same to be delivered to the display.

The one or more images may include a video and/or one or more still images.

The feature in the images may be a historic feature that was once in the real scene, but is no longer in the real scene at the time the real scene is being viewed by the person.

The historic feature may include an activity that once took place in the real scene but that is no longer taking place in the real scene. The one or more images may include a video of the activity.

The historic feature may include an object that was once in the real scene but that is no longer in the real scene. the one or more images may include a still image of the object.

The information presentation system may include instructions to position the hooded magnifier in front of one eye of the user while looking at the real scene with the other eye. The information storage system may contain the instructions, and the processing system may be configured to read the instructions from the information storage system and to cause the same to be delivered to the person.

The information presentation system may include instructions where the user should position himself or herself while using the information presentation system. The information storage system may contain the instructions, and the processing system may be configured to read the instructions from the information storage system and to cause the same to be delivered to the person.

One or more images may contain only a truncated portion of the feature that was once in the real scene but that is no longer in the real scene.

One or more images may contain only a portion of the real scene as seen by the second eye.

The information storage system may contain more than one version of one or more images of at least a portion of the real scene, and each version may have a different feature in it. The processing system may be configured to read a selected one of the versions from the information storage system and to cause the same to be delivered to the display.

An information presentation process may create the impression in the mind of a person viewing a real scene that the real scene contains a feature that is not in the real scene at the time the real scene is being viewed by the person. The process may include resting one end of a hooded magnifier against an area surrounding a first eye of the person, looking with the first eye through the hooded magnifier at a display that is coupled to another end of the hooded magnifier, looking with the second eye of the person at the real scene that does not contains the feature at the same time as the first eye is looking through the hooded magnifier at the display, and delivering to the display one or more images of at least a portion of the real scene with the feature in it at the same time as the first eye is looking at the display through the hooded magnifier and the second eye is looking at the real scene which does not contain the feature.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings disclose illustrative embodiments. They do not set forth all embodiments. Other embodiments may be used in addition or instead. Details that may be apparent or unnecessary may be omitted to save space or for more effective illustration. Conversely, embodiments may be practiced without all of the details that are disclosed. When the same numeral appears in different drawings, it is intended to refer to the same or like components or steps.

FIG. 1 illustrates an information presentation system.

FIG. 2 illustrates an example of a hooded magnifier.

FIG. 3 illustrates an example of a hooded magnifier that is vented.

FIG. 4 illustrates an information presentation system implemented with a hand-held video player coupled to a hooded magnifier.

FIG. 5 illustrates an information presentation process.

FIG. 6 illustrates an information presentation system being used in connection with a scene of a historic battlefield on which a battle was once fought.

FIG. 7 illustrate a composite image that is presented to person while viewing a real scene of a battle field though one eye and an information presentation system configured to display a video of a historic battle that was once fought in the real scene.

FIG. 8 illustrates a composite image that is presented to a person while viewing a real scene of a baseball that was hit to make a famous home run through one eye and an information presentation system configured to display a video of the batter who hit the home run explaining what happened while holding the ball.

FIG. 9 illustrates a composite image that is presented to a person while viewing a real scene of a complex control panel through one eye and an information presentation system configured to display a video that includes callouts superimposed on selected controls on the control panel through the other eye.

### DETAILED DESCRIPTION OF ILLUSTRATIVE EMBODIMENTS

Illustrative embodiments are now discussed. Other embodiments may be used in addition or instead. Details that may be apparent or unnecessary may be omitted to save space or for a more effective presentation. Conversely, embodiments may be practiced without all of the details that are disclosed.

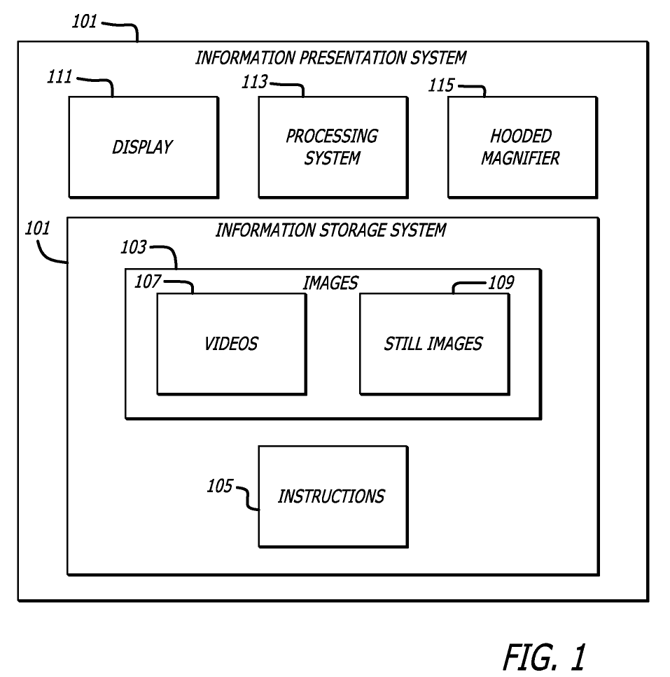

FIG. 1 illustrates an information presentation system.

As shown in FIG. 1, an information storage system 101 may include one or more images 103 and instructions 105.

The information storage system may be any type of information stored system. It may include or consist of one or more flash drives, hard drives, RAMS, ROMS, tape drives, VCRs, CDs, DVDs, and/or any other type of information storage device, or combination of them. The information storage system 101 may be a stand-alone system or part of another system, such as a portable video playback device.

The images 103 that are contained within the information storage system 101 may be of any type. They may be in a format that is compatible with the information storage system 101. For example, the images 103 may be in a digital format when the information storage system 101 consists of digital storage media. The images 103 may be in an analog format when the information storage system consists of analog storage media.

The images 103 may be of any type. They may consist of or include one or more videos 107. Each of the videos 107 may include both visual and sound content or only visual content. The images 103 may consist of or include one or more still images 109. The still images may include one or more photographs, drawings, sketches, or any other type of single-frame depiction.

Each of the images 103 may include all or part of a real scene that is expected to be viewed along with the image. Each of the images 103 may also include a feature that is depicted in the image as being in the real scene, but which is not expected to be in the real scene at the time the real scene is being viewed. The feature may or may not be a feature which was once in the real scene, but is not expected to be in the real scene at the time the real scene is being viewed.

One of the videos 107, for example, may depict all or portions of a real scene and activity that once took place in the real scene, but is no longer taking place in the real scene. An example is a famous battle. The real scene may be the battlefield. The feature may be the soldiers riding into battle on horseback. The battlefield may still exist and may still be viewable. The soldiers riding into battle, however, may be an historic event that has long-since passed.

One of the still images 109, as another example, may be a landscape that includes a building, tree, and/or a hill. The real scene may be the landscape. The building, tree, and/or hill may be the feature which was once present in the landscape, but is no longer present.

One or more of the images 103 may in addition or instead include textual information, callouts, windowed images, and/or any other type of information.

More than one of the images 103 may depict the same real scene, but with different features. For example, a set of images may be of an archaeological site at various stages of exploration. Another set of images may depict a river at different times during the year.

The instructions 105 may include instructions for the user of the information presentation system about a variety of subjects. For example, the instructions 105 may explain to the user how to use the information presentation system, where to stand while using the information presentation system, where to look, and/or any other type of instructional information. The instructions 105 may include visual information, sound information, and/or textual information. The instructions 105 may include one or more videos and/or one or more still images.

The information presentation system may include a display 111. The display 111 may be of any type. For example, the display 111 may consist of or include an LCD, a CRT, and/or any other type of display. The display 111 may be configured to display the images 103 and/or the instructions 105 which may be stored in the information storage system 101. The display 111 may be a stand-alone device or may be part of another device, such as a portable video playback device.

The display 111 may be of a size such that it may be positioned immediately in front of one eye of a person, such as between one and five inches in front of this eye, without substantially blocking the vision of the other eye of the person. More specifically, the display 111 may be sized such that, when positioned within one and five inches in front of one eye of the user, the other eye of the user may view between 90 and 120 degrees of the scene which is directly in front of that other eye, without being blocked by the display 111.

The information presentation system may include a processing system 113. The processing system 113 may consist of or include one or more processors and associated processing devices and appropriate computer software programs that are configured, under a user's control, to cause one or more of the images 103 and/or instructions 105 to be delivered to the display 111 for display to the user. The processing system 113 may be configured to perform one or more of the other operations that are described herein and/or any other operation. The processing system 113 may be a stand-alone system and/or part of another system, such as a portable video playback device.

The information presentation system may include a hooded magnifier 115. The hooded magnifier 115 may be configured to detachably attach to the display 111 and to enable one eye of a person to properly focus on the display 111 at a very close range, e.g., within one to five inches of the display 111, while simultaneously blocking out light that might otherwise wash out what is shown on the display 111 and/or create glare on the surface of the display 111.

The hooded magnifier 115 may be sized so as to not substantially block the other eye of the person from reviewing the real scene. For example, the hooded magnifier 115 may be sized so as to allow the eye of the person that is viewing the display 111 to view between 90 and 120 degrees of the real scene which is directly in front of the person.

The information presentation system may include other components that are not illustrated in FIG. 1. For example, the information presentation system may include one or more user controls to enable the user to control the images 103 and/or instructions 105 which are caused to be delivered to the display 111 by the processing system 113. The user controls may include one or more mechanical buttons, switches, and/or touch surfaces, such as the touch surfaces commonly used on portable video playback devices, and/or any other type of user input device. The information presentation system may include one or more output devices, in addition to the display 111, such as a loud speaker, headphones, and/or a Bluetooth device.

The user controls may be configured to enable the user to select the images 103 and/or instructions 105 which are sent to the display, either one at a time, or in a pre-selected sequence. The user controls may provide the user with other control options, such as to pause, stop, fast forward, fast reverse, and/or to skip portions of the presentation. The user controls may enable the user to adjust the intensity or color of the display 111, as well as the volume of any sound that is produced.

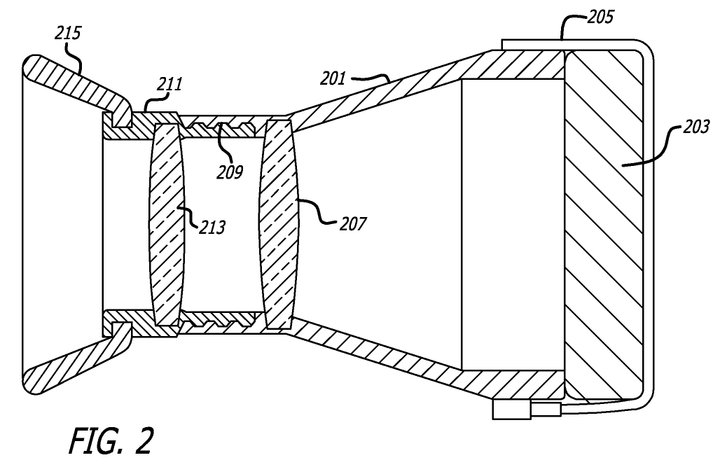

FIG. 2 illustrates an example of a hooded magnifier. The hooded magnifier that is illustrated in FIG. 2 may be used as the hooded magnifier 115 that is illustrated in FIG. 1 or in any other type of information presentation system. Similarly, the hooded magnifier 115 that is illustrated in FIG. 1 may be different from the hooded magnifier illustrated in FIG. 2.

As illustrated in FIG. 2, the hooded magnifier may include a cowling 201 that is coupled to a display 203 through the use of one or more straps 205. The display 203 may be any type of display, such as one of the types discussed above in connection with the display 111 illustrated in FIG. 1.

The cowling 201 may have a magnifying lens 207 embedded within it. The cowling 201 may include internal threads 209 which may threadingly engage external threads on an eyepiece 211 which may support an internal focusing lens 213. The eyepiece 211 may also be attached to an eye cup 215.

The cowling 201, eyepiece 211, and eye cup 215 may be configured to as permit a person to see the display 203 through the central channel of the hooded magnifier, while blocking ambient light from reaching the display 203. The cowling 201 and eyepiece 211 may be constructed from any material, such as material which does not readily pass light, such as a non-transparent plastic, metal, and/or cardboard paper. The eye cup 215 may similarly be made of any type of material, such as a material that does not readily pass light. The material may also soft and flexible, such as rubber.

The magnifying lens 207 may be sized and positioned so as to cause the image on the display 203 to be magnified so as to appear to the eye of a viewer as larger than the image actually is on the display 203. The magnifying lens 207 may be sized and positioned so as to cause the portion of the real scene which is displayed in the display 203 to appear to the eye viewing the display approximately equal in size to the real scene when it is directly viewed by the other eye of the person from a pre-determined position. The magnifying lens may be mounted on an adjustable positioning mechanism or may otherwise be configured with additional lenses to allow the degree of magnification to be adjusted by the user so that the user can adjust the viewed size of the portion of the real scene that is displayed on the display 203 to more closely match the viewed size of the real scene by the other eye.

The focusing lens 213 may be configured so as to enable a viewer to clearly focus on the display 203, notwithstanding the fact that the display 203 may be very close to an eye of the viewer, such as within one to five inches. To accommodate variations among eyesight, the position of the focusing lens 213 may be adjusted by rotating the eyepiece 211 until the image on the display 203 becomes focused for the particular user.

The straps 205 may be configured to enable the display 203 to be releasably attached to the cowling 201, thus enabling the display 203 to be used for other purposes when not attached to the cowling 201. The straps 205 may be elastic to facilitate this function. Any other type of releasable attachment mechanism to attach the cowling 201 to the display 203 may be used in addition or instead. The attachment mechanism may apply sufficient force to the display 203 so as to block light from entering through the juncture between the display 203 and the cowling 201.

The overall size of the hooded magnifier illustrated in FIG. 2 may be such as to permit the display 203 to be viewed at a close distance to one eye of the viewer, such as between one and five inches. The hooded magnifier may also be configured so as to not substantially block the view of the other eye of the person, while the hooded magnifier is placed up against the one eye of the viewer. While in this position, for example, the hooded magnifier may be of a sufficiently small size so as to enable the other eye of the viewer to view between 90 and 120 degrees of the scene which is directly in front of the person.

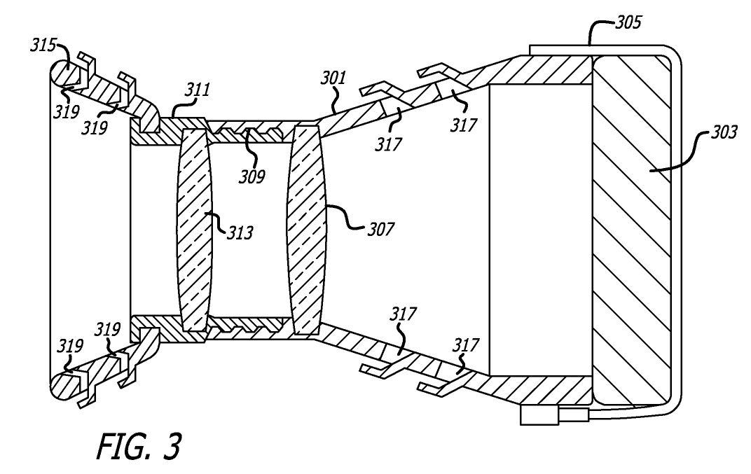

FIG. 3 illustrates an example of a hooded magnifier that is vented. The hooded magnifier may include a cowling 301 that is detachably attached to a display 303 by one or more straps 305. It may also include a magnifying lens 307, interior threads 309 on the cowling 301, an eyepiece 311 having mating external threads, a focusing lens 313, and an eye cup 315. Except as now discussed, the cowling 301, the display 303, the straps 305, the magnifying lens 307, the interior threads 309, the eyepiece 311, the focusing lens 313, and the eye cup 315 may be of the same type or different as the correspondingly-named component illustrated in FIG. 2 and described above.

In connection with the hooded magnifier illustrated in FIG. 3, the cowling 301 may include one or more light-baffling vents 317. Each vent may be configured to allow heat and moisture that may gather on the interior of the hooded magnifier during use to escape and to allow fresh air to enter, thereby minimizing discomfort to the user and minimizing the likelihood that the display 303 may become fogged by moisture from the user. The eye cup 315 may similarly be configured with one or more light-baffling vents 319 configured in a similar way to the light-baffling vents 317 to provide a similar function.

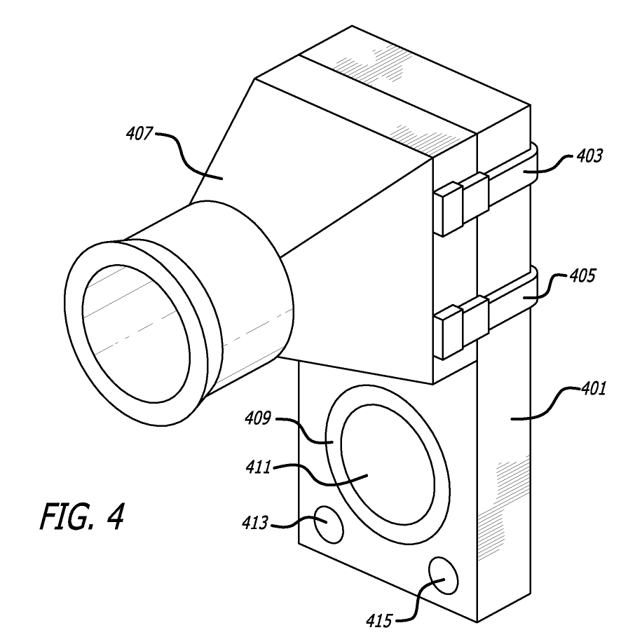

FIG. 4 illustrates an embodiment of an information presentation system implemented with a hand-held video playback device coupled to a hooded magnifier. As illustrated in FIG. 4, a video playback device is detachably coupled by elastic straps 403 and 405 to a hooded magnifier 407.

The video playback device 401 may be any type of video playback device, such as an iPod or other type of MP3 player. The video playback device 401 may include one or more user controls, such as touch controls 409, 411, 413, and 415.

The video playback device 401 may include one or more components of the information presentation system that is illustrated in FIG. 1 and discussed above. For example, it may include the display 111. Although not directly visible in FIG. 4, the display 111 may be positioned at the end of the interior chamber of the hooded magnifier 407.

The straps 403 and 405 may be of any type, such as one of the types discussed above in connection with the straps 205 illustrated in FIG. 2. Any other type of mechanism may be used to reversibly attach the hooded magnifier 407 to the video playback device 401.

The hooded magnifier 407 may be of any type. For example, the hooded magnifier 407 may be of the type described above in connection with FIG. 2 and/or FIG. 3.

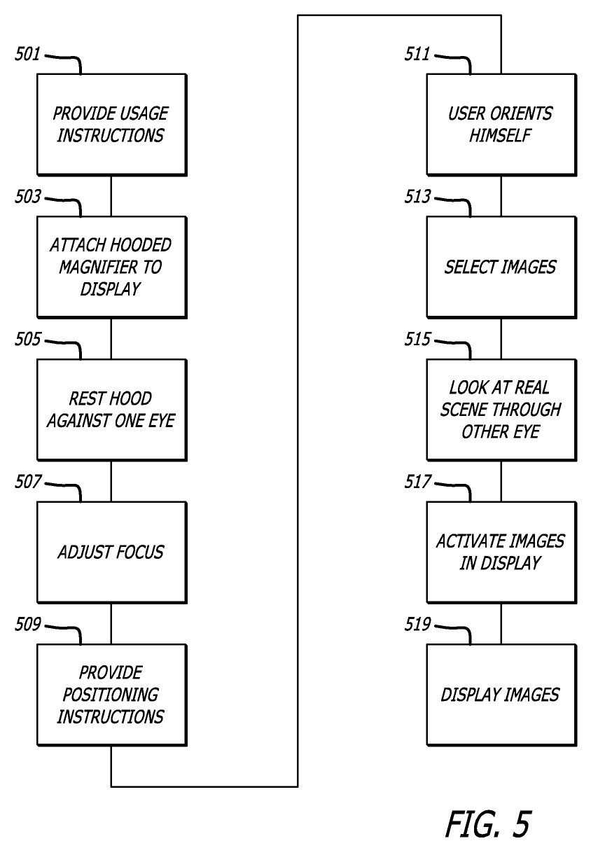

FIG. 5 illustrates an information presentation process. This process may be used in connection with the information presentation systems illustrated in FIGS. 1 and/or 4 and/or in connection with any other type of information presentation system. Similarly, the information presentation systems illustrated in FIG. 1 and/or FIG. 4 may be used in connection with any other type of information presentation process.

As illustrated in FIG. 5, the information presentation system may provide instructions to the user on its use, as reflected by a Provide Usage Instructions step 501. Such instructions may explain to the user how to attach and/or detach the hooded magnifier of the information presentation system to its display. The user instructions may in addition or instead instruct the user on how to utilize the user controls that may be part of the information presentation system and/or in connection with any other aspect of its use.

These instructions may be provided in any form. For example, they may include visual information which is delivered to the display, and/or sound information.

The user or other person may attach the hooded magnifier to the display as reflected by an Attach Hooded Magnifier To Display step 503. When elastic straps form a portion of the hooded magnifier, the user may simply stretch the straps, place the display against the cowling of the hooded magnifier, and release the straps to hold it in place.

Following assembly, the user may rest the eye cup of the hooded magnifier against one eye of the user, as reflected by a Rest Hood Against One Eye step 505. The user may apply enough pressure between the eye cup and the area surrounding the user's eye to ensure that light does not enter into the central area of the hooded magnifier, but not so strongly as to cause discomfort to the user. The user may adjust the orientation of the information presentation system so that the images on the display have a desired orientation. The user may adjust the lateral angling of the information presentation system so as to maximize the portion of the real scene which may be viewed by the eye which is not viewing the information presentation system. As previously indicated, the size, shape and orientation of the information presentation system may be such as to permit the eye which is not viewing the system to view between 90 and 120 degrees of the real scene which is directly in front of the person.

The user may adjust any focusing device which may be provided so as to enable the user to clearly view the display, as reflected by an Adjust Focus step 507. The optics of the information presentation system may be configured to enable the user to clearly focus upon the display, even when the user normally wears glasses but is not using them at the time that the information presentation system is being used. This adjustment may be facilitated through any means, such as by rotating the eyepiece of the hooded magnifier in one direction or another until the display comes in sharp focus.

The user may cause the information presentation system to provide positioning instructions to the user, as reflected by a Provide Positioning Instructions step 509. The user may do so by operating one or more user controls. The positioning instructions may instruct the user where to stand and/or where to look. These instructions may direct the user to view a particular scene from a particular viewpoint. These positions may be selected so that the images which are displayed may appear in the mind of the user at a virtual position that is most effective with respect to the real scene that is being viewed.

These positioning instructions may be provided in any form. For example, they may include text that is displayed and/or verbal instructions that are audibly communicated. The positioning instructions may in addition or instead include a display of the scene and visual markers indicating where the user should stand and/or what direction the user should face. The visual display may in addition or instead refer the user to specified points or objects of interest in the real scene on which the user should focus.

The user may comply with the instructions by moving to the designated location and/or by rotating his head to the correct position, as reflected by a User Orients Himself step 511.

Once in position, or at any earlier time, the information presentation system may optionally present the user with the opportunity to select one or more images to be viewed, as reflected by a Select Images step 513. During this step, the user may select one or more images that are of interest to be viewed. For example, the user may select the time period during which the user may wish to see what the real scene looked like, such as 100 years ago. In addition or instead, the user may select a sequence of images to be displayed. The information presentation system may facilitate this selection by displaying a menu of images, from which the user may make one or more selections.

The user may view the real scene through the other eye of the user at the instructed location and in the instructed direction, as reflected by a Look At Real Scene Through Other Eye step 515.

Once the user is properly positioned to see the information presentation, the user may actuate a user control so as to cause the images from the information presentation system to be displayed to the user, as reflected by an Activate Images in Display step 517. The information presentation system may present one or more images to one eye of the user in response, while the user is observing the real scene through the other eye, as reflected by a Display Images step 519.

Although having described certain steps of an information presentation process in a certain order, these steps may take place in a different order. Certain steps may be omitted and certain steps which have not been described may be added.

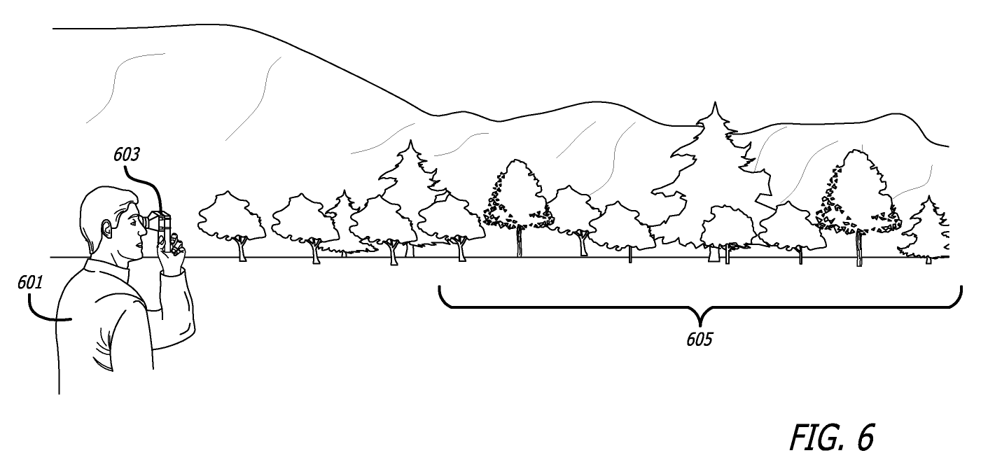

FIG. 6 illustrates an information presentation system being used in conjunction with a scene of a historic battlefield on which a battle was once fought. As reflected in FIG. 6, a viewer 601 has placed an information presentation system 603 up against one eye of the user and is looking through the other eye at a real scene 605 of a field on which a famous battle once took place. The information presentation system 603 may be any of the types of the information presentation systems which have thus-far been described, such as the information presentation system illustrated in FIG. 4.

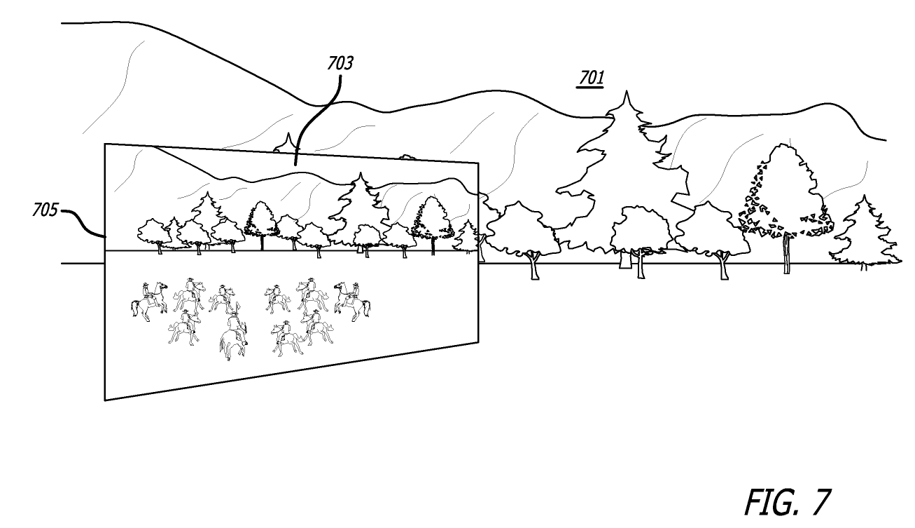

FIG. 7 illustrates a composite image that is presented to a person while viewing a real scene of a battlefield through one eye and an information presentation system configured to display a video of a historic battle that was once fought in the real scene. As illustrated in FIG. 7, a real scene 701 of a battlefield is being viewed, which may be the same as the real scene 605 illustrated in FIG. 6. The real scene 701 is being viewed by an unobstructed eye of a viewer, such as the unobstructed eye of the viewer 601 illustrated in FIG. 6. An image 703 on a display 705 is being viewed by the other eye of the viewer, such as is also illustrated in FIG. 6. As illustrated in FIG. 7, the image 703 includes soldiers riding horses which are not actually in the real scene 701 at the time of the viewing.

The image 703 may be a single photograph or a video. It may or may not be accompanied by sound, such as by the sound of the soldiers riding horses and/or a narrator explaining what is taking place.

The brain of the viewer, such as the brain of the viewer 601 in FIG. 6, may nevertheless merge the image of the real scene 701 with the image 703 on the display 705 so as to create the impression in the mind of the viewer that the soldiers are actually riding the horses in the real scene 701. This mental compositing of both the real scene and the image on the display may enhance the effectiveness of the presentation and the ability of the brain to recall the presentation.

The registration between the image of the real scene 701 and the image on the display 705, as perceived in the mind of the viewer, may be affected by the position of the user and the orientation of the user's head. In some cases, the user may be directed to a location and an orientation which causes substantial similarities in the perspective of the images of the real scene and on the display, as well as an alignment between certain aspects of these images. For example, and as illustrated in FIG. 7, the horizontal position of the mountains in the real scene may be closely aligned with the horizontal position of the mountains in the displayed image. The magnification which is provided by the hooded magnifier in connection with the displayed image may also be configured and/or set to cause the width of objects which are seen in the displayed image to be substantially the same as the width of the objects that are seen in the real scene.

As also reflected in FIG. 7, the user may be directed to position his head such that there is substantial vertical registration between aspects of the real scene and the displayed image. For example, and as illustrated in FIG. 7, the baseline of the mountain in the real scene may be substantially aligned with the base line of the mountain in the displayed image. This again may enhance the effectiveness of the composited images, as well as the user's recollection of them.

The instructions which are provided to the user to effectuate this registration may vary. In some cases, the user may simply be told to go to a certain location and to look in the direction of a certain point or object. In other cases, the user may be told to adjust his position and/or orientation so as to effectuate a registration between certain points, lines, and/or objects in the real scene and the displayed images. A combination of these methods may also be used. For example, the user might be told in connection with the scene illustrated in FIG. 7 to go to a certain spot and to look generally at the mountains. The image 703 may then be displayed in the display 705, following which the user may be told to rotate his head horizontally until the crest of the mountains align horizontally and to rotate his head vertically until the baselines of the mountains align vertically. When the presentation is a video, the information presentation system may pause, either automatically or under the control of the user, until the user effectuates these instructed alignments. In some embodiments, the magnification may also be adjusted, thus giving the user an additional means to more precisely align the registration between the real scene and the displayed images.

Although a fairly close registration is illustrated in FIG. 7, in other embodiments, the registration may not be as precise and/or as important. Indeed, the real scene and the displayed images may be deliberately offset from one another in some applications. Still, the brain may perceive the two as being part of the same scene.

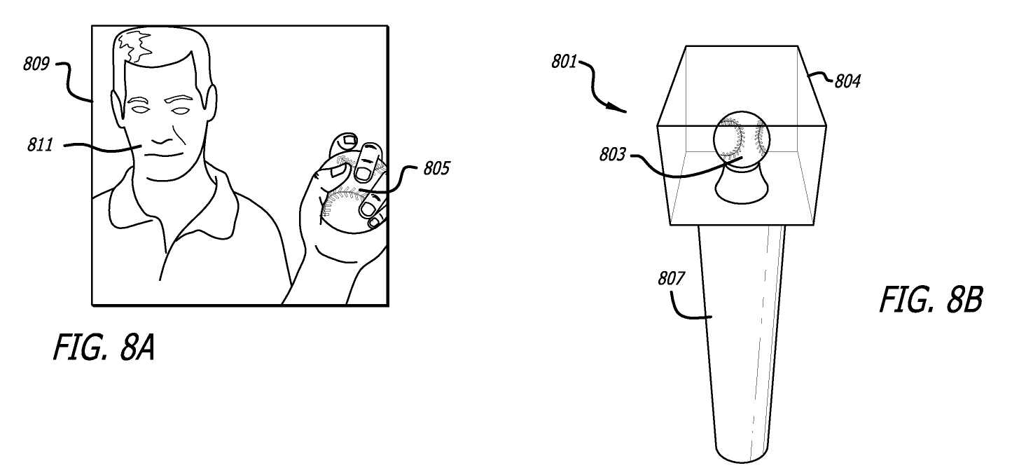

FIG. 8 illustrates a composite image that is presented to a person while viewing a real scene of a baseball that was hit to make a famous homerun through one eye and an information presentation system configured to display a video of the batter who hit the homerun explaining what happened while holding the ball. As illustrated in FIG. 8, a real scene 801 includes a baseball 803 that was hit to make a famous homerun that is being viewed through one eye of an observer. The baseball is shown encased in a clear casing 804 on top of a pedestal 807. The real scene may be part of a room in a museum.

A display 809 which is part of an information presentation system of one of the types discussed above may be simultaneously displaying through a hooded magnifier to the other eye of the user a baseball 805 which is an image of the real baseball 803 while being held by the batter 811 who made the homerun using the baseball 805. The display 809 may display a single photograph, a series of photographs, and/or a video.

During the display, the sound of the batter 811 explaining his famous hit may be delivered to the user. If the image being displayed on the display 809 is a video, the video may be of the batter 811 presenting this explanation. The display 809 may also or instead be used to display the batter 811 hitting the ball 805, as well as other aspects of this play. Again, the juxtaposition of a real scene with an image of at least part of the real scene and an object that is not presently in the real scene can create the impression in the mind of the user of the object actually being present in the real scene and can enhance the user's recollection of the information that is presented by the information presentation system and the real scene.

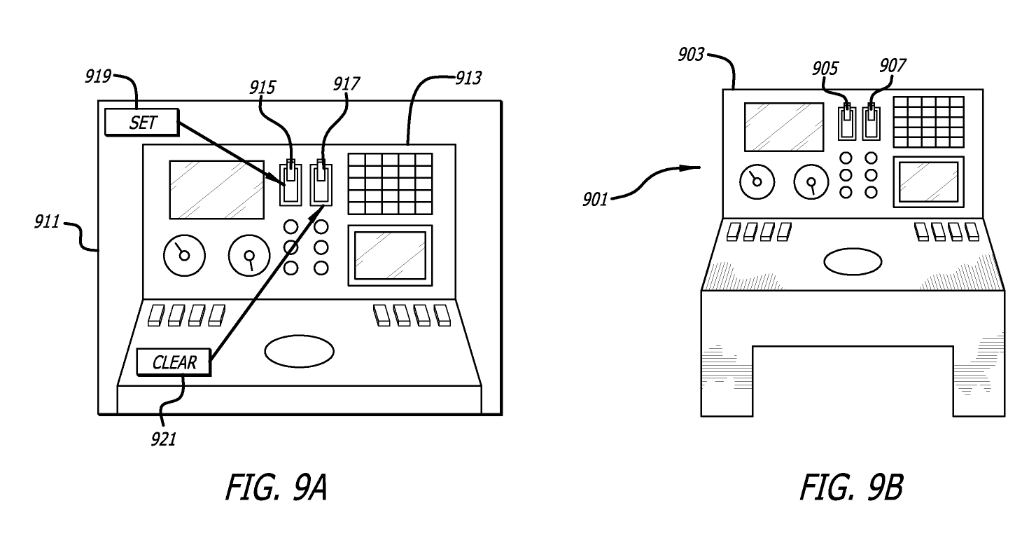

FIG. 9 illustrates a composite image that is presented to a person while viewing a real scene of a complex control panel through one eye and an information presentation system configured to display a video that includes callouts superimposed on selected controls of the control panel through the other eye. As illustrated in FIG. 9, a real scene 901 includes a complex control panel 903 and controls on that control panel, such as controls 905 and 907. A display 911 on the information presentation system may illustrate a portion of the very same control panel 913 containing images of the same controls 915 and 917. In addition, the display may include a numeric label 919 for the control 915 and a numeric label 921 for the control 917. The labels may be presented along with either textual or audible narrations which provide more information about these specific controls that are being highlighted. Although the control panel 903 and the display 911 are illustrated as being physically displaced from one another, the user may instead position himself so as to cause the two to partially or completely overlap.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

For example, the information presentation systems and processes which have been discussed have thus-far only been discussed in connection with certain specific applications. However, these same systems and processes may be used with a broad variety of other applications.

For example, the real scene of an important geological site may be accompanied by an information presentation system that displays the highlights of the various layers in that sight and a geologist explaining each layer. The information presentation system may also display various stills showing close-ups of various rocks and minerals within the site.

Another example is a real scene of a sculpture, painting or object located indoors. The information presentation system may display a portion of the sculpture, painting or object, along with the person who created the sculpture, painting or object pointing out various facets of it.

A still further application may be the real scene of an Indian village. The information presentation system may display images of the village as it looked five hundred years ago. Actors may also be displayed demonstrating various activities that took place five hundred years ago at the site.

A still further example may be the real scene of a historic building. The information presentation system may highlight various structural elements of the building and feature cut-away views of certain aspects of the construction, architecture, and/or other images of interest.

As discussed above, moreover, all of the components in the information presentation system, except for the hooded magnifier, may be implemented with a single portable video playback device, such as an iPod or other MP3 player. In other embodiments, the display and other components may be separate from one another. For example, certain components of the information presentation system may be packaged in a container that is carried or strapped to the user, while only the display may be placed in front of one eye of the user.

In other embodiments, certain components of the information presentation system, such as the processing system and the information storage system, may be located remotely and placed in communication with the display through appropriate wireless technology.

The information presentation system may be powered by any means, such as by battery, sunlight, and/or line voltage.

The phrase “means for” when used in a claim embraces the corresponding structures and materials that have been described and their equivalents. Similarly, the phrase “step for” when used in a claim embraces the corresponding acts that have been described and their equivalents. The absence of these phrases means that the claim is not limited to any of the corresponding structures, materials, or acts or to their equivalents.

Nothing that has been stated or illustrated is intended to cause a dedication of any component, step, feature, object, benefit, advantage, or equivalent to the public, regardless of whether it is recited in the claims.

In short, the scope of protection is limited solely by the claims that now follow. That scope is intended to be as broad as is reasonably consistent with the language that is used in the claims and to encompass all structural and functional equivalents.

I claim:

1. An information presentation system for creating the impression in the mind of a person viewing a real scene that the real scene contains a feature that is not in the real scene at the time the real scene is being viewed by the person, comprising:
a display configured to display visual images, the display having a size that is viewable by a first eye of the person at close range without substantially blocking the view of the second eye of the person;
a hooded magnifier that has an end coupled to the display and another end configured to rest against area around the first eye of the person without substantially blocking the view of the second eye of the person, the hooded magnifier having an optical lens that is configured to comfortably allow the first eye of the person to focus on the images that are displayed by the display at close range and a hood that substantially blocks ambient light from reaching the first eye of the person when the other end of the magnifier is rested against the area around the first eye;
an information storage system containing one or more images of at least a portion of the real scene with the feature in it; and
a processing system configured to read the one or more images from the information storage system and to cause the same to be delivered to the display.

2. The information presentation system of claim 1 wherein the one or more images includes a video.

3. The information presentation system of claim 1 wherein the one or more images includes one or more still images.

4. The information presentation system of claim 1 wherein the feature is a historic feature that was once in the real scene, but is no longer in the real scene at the time the real scene is being viewed by the person.

5. The information presentation system of claim 4 wherein the historic feature includes an activity that once took place in the real scene but that is no longer taking place in the real scene and wherein the one or more images includes a video of the activity.

6. The information presentation system of claim 4 wherein the historic feature includes an object that was once in the real scene but that is no longer in the real scene and wherein the one or more images includes a still image of the object.

7. The information presentation system of claim 1 further comprising instructions to position the hooded magnifier in front of one eye of the user while looking at the real scene with the other eye.

8. The information presentation system of claim 7 wherein the information storage system contains the instructions and the processing system is configured to read the instructions from the information storage system and to cause the same to be delivered to the person.

9. The information presentation system of claim 1 further comprising instructions where the user should position himself or herself while using the information presentation system.

10. The information presentation system of claim 9 wherein the information storage system contains the instructions and the processing system is configured to read the instructions from the information storage system and to cause the same to be delivered to the person.

11. The information presentation system of claim 1 wherein the one or more images contain only a truncated portion of the feature that was once in the real scene but that is no longer in the real scene.

12. The information presentation system of claim 1 wherein the one or more images contain only a portion of the real scene as seen by the second eye.

13. The information presentation system of claim 1 wherein the information storage system contains more than one version of one or more images of at least a portion of the real scene, wherein each version has a different feature in it, and wherein the processing system is configured to read a selected one of the versions from the information storage system and to cause the same to be delivered to the display.

14. An information presentation process for creating the impression in the mind of a person viewing a real scene that the real scene contains a feature that is not in the real scene at the time the real scene is being viewed by the person, comprising:
resting one end of a hooded magnifier against an area surrounding a first eye of the person;
looking with the first eye through the hooded magnifier at a display that is coupled to another end of the hooded magnifier;
looking with the second eye of the person at the real scene that does not contains the feature at the same time as the first eye is looking through the hooded magnifier at the display; and
delivering to the display one or more images of at least a portion of the real scene with the feature in it at the same time as the first eye is looking at the display through the hooded magnifier and the second eye is looking at the real scene which does not contain the feature.

15. The information presentation process of claim 14 wherein the one or more images includes a video.

16. The information presentation process of claim 14 wherein the one or more images includes one or more still images.

17. The information presentation process of claim 14 wherein the feature is a historic feature that was once in the real scene, but that is no longer in the real scene at the time the real scene is being viewed by the person.

18. The information presentation process of claim 17 wherein the historic feature includes an activity that once took place in the real scene, but that is no longer taking place in the real scene.

19. The information presentation process of claim 17 wherein the historic feature includes an object that was once in the scene, but that is no longer in the scene.

20. The information presentation system of claim 14 wherein the one or more images contain only a portion of the real scene as seen by the second eye.
